(19) United States
(12) Patent Application Publication
(10) Pub. No.: US 2012/0203470 A1
(43) Pub. Date: Aug. 9, 2012

(54) Measurement Method

(75) Inventors: Ralf BITTER, Karlsruhe (DE); Camiel Heffels, Stutensee-Buchig (DE); Thomas Hörner, Karlsruhe (DE); Martin Kionke, Karlsruhe (DE)

(73) Assignee: Siemens Aktiengesellschaft, Muenchen (DE)

(21) Appl. No.: 13/365,502

(22) Filed: Feb. 3, 2012

(30) Foreign Application Priority Data
Feb. 4, 2011 (EP) EP11153450

(51) Int. Cl. G06F 19/00; G06F 15/00

(52) U.S. Cl. 702/24; 702/127

(57) ABSTRACT

A measurement method in which, at the start of a measurement chain, a measured variable is picked up and is further-processed over the course of the measurement chain by conversion to generate a measurement result, where the original or converted measured variable is modulated at a predetermined modulation frequency at a first point in the measurement chain. At a second point in the measurement chain or sequence, which is after the first point in the direction of further-processing, a variable is added to the converted measured variable. The measurement chain or sequence is calibrated using different known values for the measured variable, where different vectors are obtained that define a characteristic, and an unknown value for the measured variable is determined from that point of the characteristic at which the vector obtained in the process or its extension intersects the characteristic.

### BACKGROUND OF THE INVENTION

1. Field of the Invention

The invention relates to processing of signal measurement and more particularly, to a measurement method in which, at the start of a measurement chain or sequence, a measured variable is picked up and further-processed over the course of the measurement chain or sequence by conversion to generate a measurement result, where the original or converted measured variable is modulated at a predetermined modulation frequency at a first point in the measurement chain.

2. Description of the Related Art

A measurement chain for measuring an electrical or non-electrical measured variable comprises different measurement elements for recording the measured variable, generating an electrical measurement signal suitable for further-processing, matching, such as digitization, filtering, amplification, equalization of the measurement signal and output of a measurement result (measured value). A pickup is used to convert the measured variable either directly or via other physical variables into the electrical measurement signal. For example, in the case of paramagnetic oxygen measurement, use is made of the effect that oxygen molecules in a measurement gas move in an inhomogeneous magnetic field in the direction of higher field strength. Resultant changes in the local gas density, flows or changes in pressure can be detected by suitable detectors, such as thermal conductivity, flow or pressure detectors, and converted into an electrical signal for further-processing, as disclosed for example in DE 8703944 U1, WO 98/12552 A1, DE 19803990 A1, DE 102005014145 A1.

In many cases, the original or converted measured variable is modulated at a predetermined modulation frequency to obtain an alternating signal that can be processed more easily and with fewer faults. Thus, subsequent demodulation of the measurement signal by a lock-in amplifier makes it possible to process very small measurement signals, even in the presence of extreme noise. In the case of a paramagnetic oxygen measurement, the modulation is performed by the magnetic field (alternating field). As a result, for example, an alternating gas flow that is proportional to that of the oxygen content of the measurement gas is obtained, where this alternating gas flow is converted into an electrical alternating measurement signal. This measurement signal is also dependent on the modulation depth, in this case the amplitude of the magnetic field, however, with the result that fluctuations or creeping changes in the generation of the magnetic field have a disruptive influence on the measurement result, in the same way as external magnetic interference fields (e.g., from adjacent paramagnetic oxygen meters).

In addition, the measurement result can be adversely affected by changes in the measurement elements processing the measurement signal or by disruptive influences from the outside. Examples of this are ageing-dependent or temperature-dependent detector or electronic drifts, or interference fields.

### SUMMARY OF THE INVENTION

It is therefore an object of the invention to identify changes in a measurement chain or sequence with respect to a calibration state and to compensate the influence of these changes on the measurement result.

This and other objects and a advantages are achieved in accordance with the invention by providing a measurement method in which, at the start of a measurement chain, a measured variable is picked up and is further-processed over the course of the measurement chain by means of conversion to give a measurement result, where the original or converted measured variable is modulated at a predetermined modulation frequency at a first point in the measurement chain. In accordance with the invention, the method comprises adding a variable to the converted measured variable at a second point in the measurement sequence, which is after the first point in the direction of further-processing, where the variable has the same frequency as the modulation but is shifted with respect to this frequency through a predetermined phase angle, with the result that the measurement result contains a vector described by amplitude and phase. The measurement chain or sequence is then calibrated using different known values for the measured variable, where different vectors are obtained that define a characteristic, and an unknown value for the measured variable is determined from that point of the characteristic at which the vector obtained in the process or its extension intersects the characteristic.

By virtue of a phase-shifted variable of the same frequency being added to the modulated measured variable which has been converted, for example, into a measurement signal or a physical intermediate variable, a measurement signal vector is produced for the further-processing that is characterized by magnitude and phase. In the case of calibration of the measurement chain or sequence with different known values for the measured variable, the vectors obtained in the process for the measurements result define a characteristic. As long as, during a subsequent measurement, the measurement conditions in the measurement chain or sequence correspond to the calibration conditions, a vector is obtained as the measurement result which points to a point in the characteristic. As a result, the unknown value of the measured variable can be determined from this point. In the case of a fault, whether the fault is in an element of the measurement chain or sequence or acts on the measurement chain or sequence from outside, the magnitude of the vector will change. Consequently, the peak of the result vector will be outside the characteristic. As a result, the presence of a fault can be diagnosed very easily. A fault substantially influences the magnitude of the vector, but does not influence or barely influences its phase. It is therefore possible to correct the measurement result by shortening or lengthening the result vector given an unchanged phase angle up to the characteristic. From this point on the characteristic, the correct value for the measured variable can then be determined.

The modulation of the measured variable can also be subject to faults. Consequently, the variable that is added to the converted measured variable is preferably derived from the modulation of measured variables such that the amplitude of the added variable is proportional to the modulation depth.

In the case of a paramagnetic measurement of the oxygen content of a measurement gas, the measured variable (e.g., oxygen content) is converted into an intermediate variable (e.g. flow or pressure), which is ultimately converted into a further-processable electrical measurement signal. The conversion of the measured variable into the intermediate variable is performed by an alternating magnetic field, which is also used for modulating the converted measured variable. Here, within the context of the disclosed invention, a comparison variable (e.g., constant oxygen content of a comparison gas) is also converted into a corresponding intermediate variable (e.g., flow or pressure), preferably with the same magnetic field. The intermediate variables obtained from the measured variable and from the comparison variable are added or subtracted with a phase shift before they are converted into the electrical measurement signal. Alternatively, the two intermediate variables are converted separately into electrical measurement signals, which are then added or subtracted, with either the addition or subtraction or the generation of the intermediate variables occurring with a phase shift. If the intermediate variable is the flow or the pressure of a gas, the phase shift can be set by the length of the line or generally by a pneumatic filter between the point at which the intermediate variable is generated and the point at which the intermediate variable is detected.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

For further explanation of the invention, reference is made below to the figures in the drawing, in which:

FIG. 1 is an exemplary schematic block diagram of a simplified measurement chain or sequence in accordance with the invention;

FIG. 2 is a simplified graphical plot of the determination of a measurement result from a characteristic formed by vectors in accordance with the invention;

FIGS. 3 and 4 are two simplified exemplary schematic block diagrams of the formation of a variable that is phase-shifted with respect to the modulation of the measured variable in accordance with the invention;

FIGS. 5 to 7 are different exemplary schematic block diagrams of a paramagnetic oxygen measurement arrangement in accordance with the invention; and

FIG. 8 is a flowchart of the method in accordance with an embodiment of the invention.

### DETAILED DESCRIPTION OF THE PREFERRED EMBODIMENTS

FIG. 1 shows a simplified block circuit diagram of a measurement chain or sequence for measuring a measured variable S. The measured variable S is picked up by a first measurement element (pickup) 1 and converted into an electrical measurement signal S1. The electrical measurement signal S1 is processed in further measurement elements, such as an analog amplifier 2, an analog-to-digital converter 3 and a computation device 4 (e.g., a microprocessor), to create a measurement result E. During pickup of the measured variable S, a modulation with a modulation signal M of frequency f₀ is performed at a point 5, with the result that the measurement signal S1 is an alternating signal or contains an alternating signal component, which is dependent on the measured variable S and the modulation amplitude and has the frequency f₀. For example, the pickup is a thermal conductivity detector with a heating filament, with a measurement gas flowing around it. As a result, thermal energy flows away from the heating filament depending on the specific thermal conductivity of the gas to be measured. Due to the heat flowing away, the heating filament is cooled. Consequently, its electrical resistance and therefore the electrical heating current is dependent on the thermal conductivity of the gas. Here, the modulation is such that the heating current is produced by an AC voltage source.

At a second point 6 in the measurement chain or sequence, which is after the point 5 at which the modulation occurs, a variable N is added to the as yet unconverted measured variable, in this case the measurement signal S1, where the variable N has the same frequency f₀ as the modulation signal M but is shifted with respect thereto through a fixed phase angle φ₀ (owing to the fact that N(φ₀)=−N(180°+φ₀), addition and subtraction are equivalent in this case. Over the further course of the measurement chain or sequence, therefore, the signal S2=S1+N is processed.

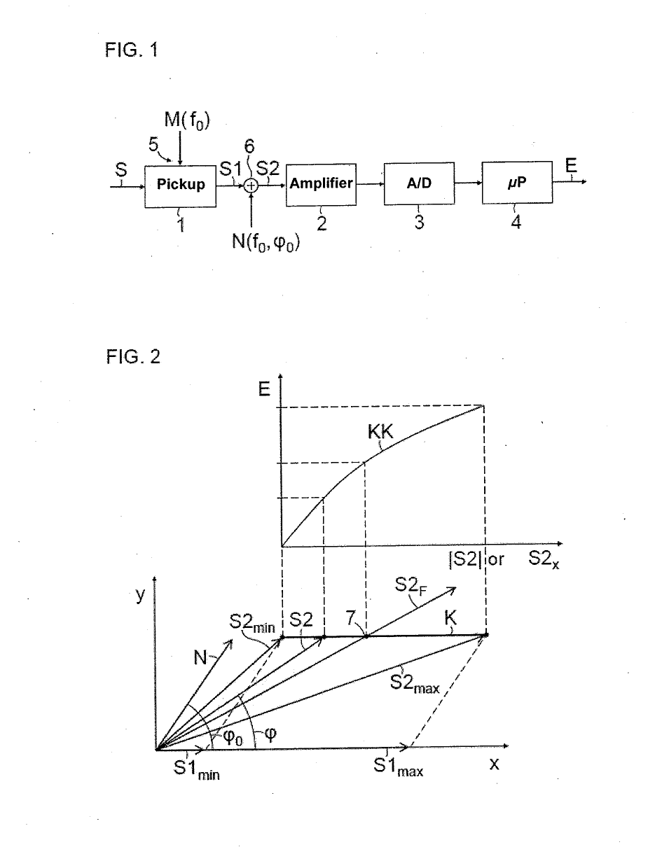

FIG. 2 shows, in an x-y coordinate system on the x-axis, a graphical plot of the variation range S1ₘᵢₙ-S1ₘₐₓ of the measurement signal S1 in a measurement range between a minimum measured value Sₘᵢₙ and a maximum measured value Sₘₐₓ (Sₘᵢₙ and S1ₘᵢₙ can also be zero). By virtue of the addition of the variable N with the φ₀ shift with the measurement signal S1, the signal S2 is produced as a vector with an amplitude |S2| and a phase φ. If, during calibration of the measurement chain or sequence, the measured variable S varies between Sₘᵢₙ and S1ₘₐₓ, the vectors obtained in the process define a characteristic K in the coordinate system. In this case, there is a clear association between each point on the characteristic K and the length |S2| of the vector S2 or its x-component S2ₓ. It is therefore possible, as can be seen from the upper part of FIG. 2, for the measurement result (measured value of the measured variable S) to be determined from each vector length |S2| or each x-component S2ₓ of the vector S2 via a calibration characteristic KK.

The calibration characteristic KK is stored in the computation device 4. The vector length |S2| corresponds to the magnitude of the signal S2. Alternatively, the x-component S2ₓ can be extracted from the signal S2 by a lock-in amplifier (e.g., amplifier 2).

If the conditions within the measurement chain or sequence after the point 6 at which the variable N is introduced change, for example, if the gain of the amplifier 2 changes by electronic drift or an interference signal component is induced by an external interference field, this acts in the same way on both components S1 and N of the signal S2=S1+N. That is, a faulty signal S2_{F} is obtained whose vector peak is outside the characteristic K (FIG. 2). In addition to the identification of the fault or the interference, however, this can also be compensated for by virtue of the vector S2_{F} being shortened or lengthened, with an unchanged phase angle, up to the characteristic K (point 7). It is then possible for the calibration characteristic KK to be used to determine the correct measured value from the length or the x-component of the thus corrected vector.

Since only faults and interference that occur after the point 6 at which the variable N is introduced are identified and compensated for, this point is preferably as close as possible to the point 5 at which the modulation occurs.

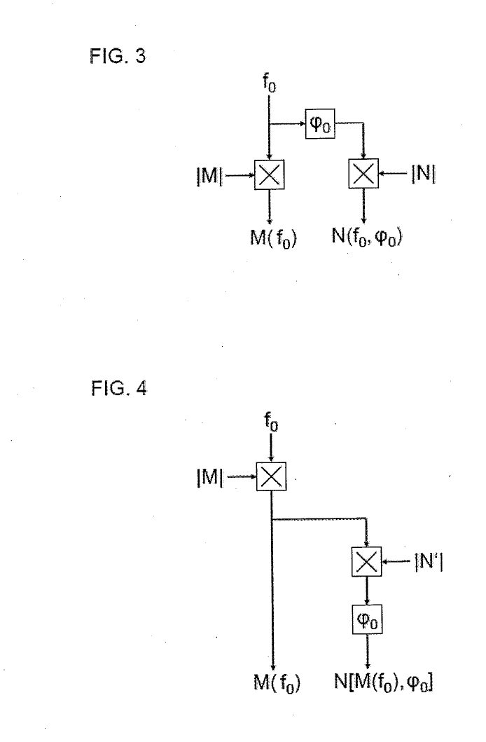

As schematically depicted in FIG. 3, in the simplest case the variable N is generated with a constant amplitude |N| in synchronism with the frequency f₀ of the modulation signal M and with the phase shift φ₀. It is thus possible, for example, in the case of paramagnetic oxygen measurement, to obtain a signal N of the same frequency from the alternating current used to generate the magnetic field, with this signal being added to the measurement signal S1 with a constant phase shift.

However, it is also possible for the modulation itself to be subject to interference and changes, for which reason the variable N is preferably obtained from the modulation signal M itself, as shown in FIG. 4, with the result that the amplitude |N| of the variable N is proportional to the modulation depth |M|. If the modulation amplitude changes, i.e., the strength of the alternating magnetic field in the case of a paramagnetic oxygen measurement, for example, this is identified and compensated for in the same way as previously described with reference to FIG. 2.

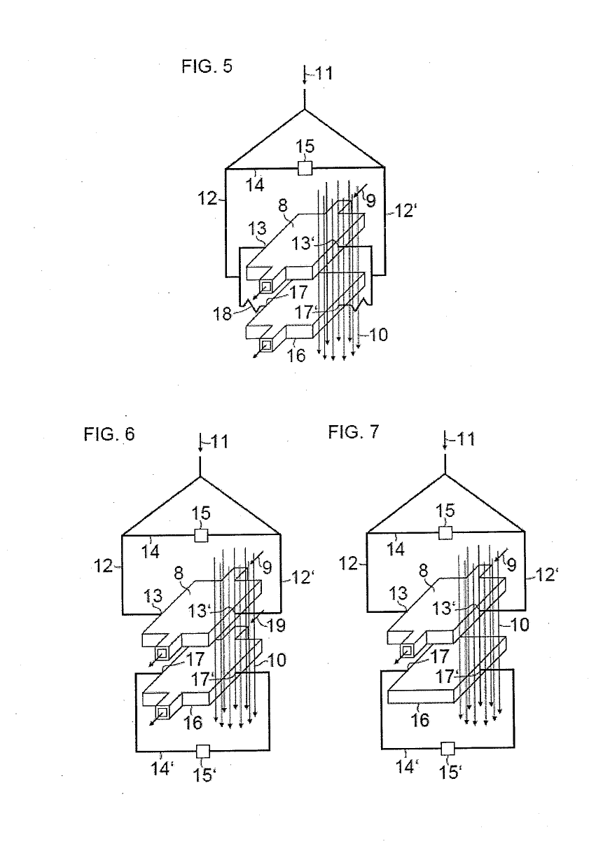

FIG. 5 shows an exemplary paramagnetic oxygen measurement arrangement. This substantially comprises a flat and elongate measurement chamber 8, through which a measurement gas 9, whose oxygen content is intended to be determined, flows in the direction of the longitudinal axis of the measurement chamber. Part of the measurement chamber 8 is in the magnetic field 10 of an electromagnet (not shown here for reasons of clarity) which is fed alternating current. An auxiliary or comparison gas 11 required for achieving the measurement effect flows through two auxiliary gas lines 12, 12′ of the same shape, of which one enters the magnetic-field-free space of the measurement chamber 8 centrally at a point 13 and the other opens out in the region of the magnetic field 10 at the opposite point 13′. The auxiliary gas lines 12, 12′ open out into a connecting line 14 outside the measurement chamber 8, where the connecting line has, in its center, a signal transducer 15 that responds to flow or alternating pressure, which acts as a pneumatic-electrical transducer and which outputs a measurement signal corresponding to the oxygen content of the measurement gas 9. Up to this point, the oxygen measurement arrangement is known from DE 8 703 944 U1.

In order to generate a variable that is proportional to the strength of the alternating magnetic field 10 and that has the same frequency but with a phase shift, a comparison chamber 16 is provided that is connected in parallel to the measurement chamber 8 at mutually opposite points 17, 17′ to the auxiliary gas lines 12, 12′, but only the auxiliary or comparison gas 11 flows through this comparison chamber 16, in contrast to the measurement chamber 8. As is also the case for the measurement chamber 8, with the comparison chamber 16, the connection point 17 of the auxiliary gas line 12 is in the magnetic-field-free area and the other connection point 17′ of the auxiliary gas line 12′ is in the region of the magnetic field 10. Under the proviso that the auxiliary gas 11 contains a constant oxygen content (e.g., air), an additional flow or an additional alternating pressure is produced in the connecting line 14, with this flow or alternating pressure being dependent on the magnetic field strength, but independent of the measurement gas 9. By virtue of different line lengths (i.e., delay element 18) between the measurement chamber 8 and the connecting line 14, on the one hand, and the comparison chamber 16 and the connecting line 14, on the other hand, a predetermined phase shift between the flow or alternating pressure component coming from the measurement chamber 8 and the flow or alternating pressure component from the comparison chamber 16 is achieved.

In an embodiment, the comparison chamber 16 is eliminated and the magnetic field 10 is arranged such that it acts in one of the auxiliary gas lines 12, 12′ or, when viewed from the signal transducer 15, in one side of the connecting line 14 and produces the additional flow or the additional alternating pressure there.

In another embodiment, instead of only one magnetic field 10, two alternating magnetic fields of the same frequency but with a phase shift with respect to one another are produced, of which one passes through the measurement vessel 8 and the other passes through the comparison vessel 16.

In a further embodiment the additional flow or the additional alternating pressure is directly produced by a transducer, such as a sound transducer, arranged in one of the auxiliary gas lines 12, 12′ or, when viewed from the signal transducer 15, in one side of the connecting line 14.

FIG. 6 shows an alternative exemplary embodiment of the paramagnetic oxygen measurement arrangement which differs from that shown in FIG. 5 in that an oxygen-containing comparison gas 19 flows through the comparison chamber 16 independently of the measurement chamber 8, with the result that the auxiliary gas 11 for the measurement chamber 8 can be free of oxygen, such as nitrogen. Instead of the fluidic parallel connection of the comparison chamber 16 and the measurement chamber 8, the connection points 17, 17′ are connected to one another by a separate connecting line 14′, which contains a dedicated signal transducer 15′. By virtue of different line lengths between the points 13 or 13′ and the signal transducer 15, on the one hand, and the points 17 and 17′ and the signal transducer 15′, on the other hand, a predetermined phase shift between the electrical signals produced by the two signal transducers 15 and 15′ is achieved, and these electrical signals are added to one another or subtracted from one another.

Finally, the exemplary embodiment shown in FIG. 7 differs from that shown in FIG. 6 in that the comparison chamber 16 forms a closed-off space, which is filled with the comparison gas 19.

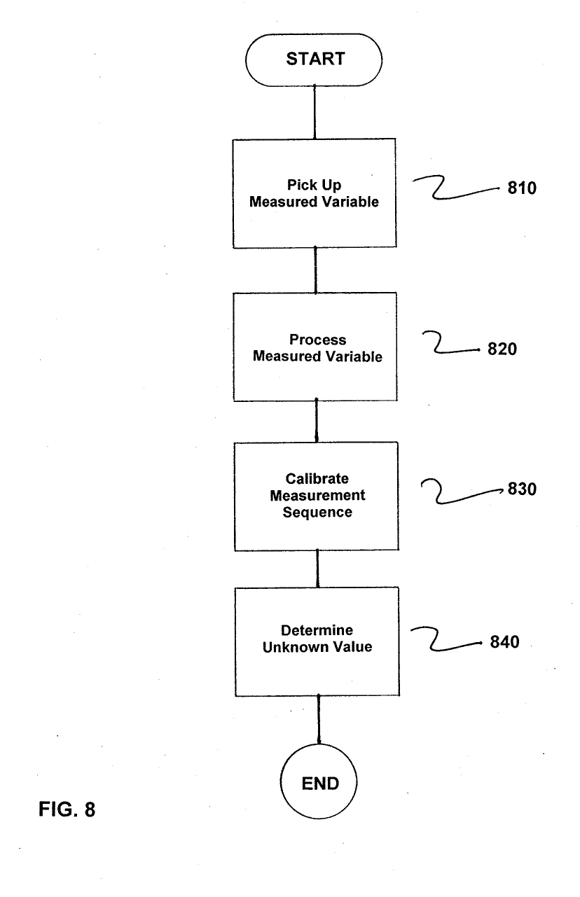

FIG. 8 is a flowchart of a method for performing measurements in accordance with the invention. The method comprises picking up a measured variable at a start of a measurement sequence, as indicated in step 810. The measured variable is processed over a course of the measurement sequence by conversion to generate a measurement result, as indicated in step 820. Here, the measurement signal or a converted measured variable of the measurement signal is modulated at a predetermined modulation frequency at a first point in the measurement sequence, the processing further comprising. In addition, a variable is added to the converted measured variable at a second point in the measurement chain, which is after the first point in the direction of further-processing, where the variable has the same frequency as the predetermined modulation frequency but is shifted with respect to the modulation through a predetermined phase angle such that the measurement result contains a vector described by amplitude and phase.

The measurement sequence is then calibrated using different known values for the measured variable, different vectors being obtained which define a characteristic, as indicated in step 830. An unknown value is determined for the measured variable from that point of the characteristic at which a vector obtained in the process or its extension intersects the characteristic, as indicated in step 840.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those method steps which perform substantially the same function in substantially the same way to achieve the same results are within the scope of the invention. Moreover, it should be recognized that method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A measurement method comprising:
picking up a measured variable at a start of a measurement sequence;
processing the measured variable over a course of the measurement sequence by conversion to generate a measurement result, the measurement signal or a converted measured variable of the measurement signal being modulated at a predetermined modulation frequency at a first point in the measurement sequence, the processing further comprising:
adding a variable to the converted measured variable at a second point in the measurement chain, which is after the first point in the direction of further-processing, said variable having a same frequency as the predetermined modulation frequency but being shifted with respect to the modulation through a predetermined phase angle such that the measurement result contains a vector described by amplitude and phase;
calibrating the measurement sequence using different known values for the measured variable, different vectors being obtained which define a characteristic; and
determining an unknown value for the measured variable from that point of the characteristic at which a vector obtained in the process or its extension intersects the characteristic.

2. The measurement method as claimed in claim 1, wherein the variable added to the converted measured variable is derived from the modulation of the measured variable such that the amplitude of the variable is proportional to a depth of the modulation.

3. The measurement method as claimed in claim 1, further comprising:
subjecting a measurement gas and a comparison gas with a constant oxygen content to an alternating magnetic field for a paramagnetic measurement of an oxygen content of the measurement gas, oxygen molecules moving in a direction of higher field strength;
wherein changes in a local density, flows or changes in a pressure of the measurement gas resulting from the movement of the oxygen molecules in the measurement gas and from the movement of the oxygen molecules in the comparison gas are one of superimposed, detected jointly and converted into an electrical signal for further-processing and detected separately, converted into two electrical signals, and signals for further-processing are added or subtracted.

4. The measurement method as claimed in claim 2, further comprising:
subjecting the measurement gas and a comparison gas with a constant oxygen content to an alternating magnetic field for a paramagnetic measurement of an oxygen content of a measurement gas, oxygen molecules moving in a direction of higher field strength;
wherein changes in a local density, flows or changes in a pressure of the measurement gas resulting from the movement of the oxygen molecules in the measurement gas and from the movement of the oxygen molecules in the comparison gas are one of superimposed, detected jointly and converted into an electrical signal for further-processing and detected separately, converted into two electrical signals, and signals for further-processing are added or subtracted.

5. The measurement method as claimed in claim 3, wherein the phase angle is produced by gas paths of different lengths provided between the points at which the measurement gas and the comparison gas are subjected to the alternating magnetic field and a location at which resultant changes in the local density, flows or changes in pressure are detected.
